(19) United States
(12) Patent Application Publication
(10) Pub. No.: US 2015/0347687 A1
(43) Pub. Date: Dec. 3, 2015

(54) METHOD AND APPARATUS FOR ACTIVATING AT LEAST ONE PATIENT ENTRY

(71) Applicant: Siemens Aktiengesellschaft, Muenchen (DE)

(72) Inventors: Heiko Kallert, Veitsbronn (DE); Stephan Nufer, Erlangen (DE); Yeliz Oezkan, Erlangen (DE)

(73) Assignee: Siemens Aktiengesellschaft, Muenchen (DE)

(21) Appl. No.: 14/728,192

(22) Filed: Jun. 2, 2015

(30) Foreign Application Priority Data
Jun. 2, 2014 (DE) 102014210329.0

(51) Int. Cl. G06F 19/00; G06F 17/30

(52) U.S. Cl. CPC G06F 19/322; G06F 17/30377

(57) ABSTRACT

In a method medical apparatus and computer system for activating at least one patient entry stored in a patient database, at least one patient entry is selected from the patient database at a first computer, a code of the at least one selected patient entry is transmitted from the first computer to a second computer, the at least one patient entry is activated at the second computer based on the code of the at least one selected patient entry that is received.

### BACKGROUND OF THE INVENTION

1. Field of the Invention

The invention relates to a method for activating at least one patient entry stored in the patient database, and a computer system and a medical apparatus for implementing such a method.

2. Description of the Prior Art

During an examination and/or treatment of a patient by operation of a medical device, a patient entry from a patient database is typically initially activated at a computer of the medical device, meaning that it is switched to active. Thereafter the information is stored as to which patient is to be examined and/or treated by means of the medical device. Thus parameters for the examination and/or treatment of the patient can be set specifically for the patient. Likewise image data and/or therapy results achieved can be stored specifically by means of the medical device for the activated patient.

In a conventional procedure, to do this the patient entry must typically be activated manually via a patient search function and/or from a patient list at the computer of the medical device for the activation.

### SUMMARY OF THE INVENTION

An object of the invention is to simplify activation of at least one patient entry at a computing device of a medical device.

In accordance with the invention, proceeds a method for activating at least one patient entry stored in a patient database, includes the following steps.

The at least one patient entry is selected from the patient database at a first computer.

A code of the at least one selected patient entry is transmitted from the first computer to a second computer.

The at least one patient entry is activated at a second computer based on the code of the at least one selected patient entry received.

For this purpose the first computer and the second computer are connected to the patient database for an exchange of data. The patient database can be, for example, a part of a hospital information system which is assigned to the medical device in which the first computer and the second computer are located.

The patient database typically has a number of patient entries, of which at least one is selected and activated at the second computer by the inventive procedure. A patient entry can be a data object in the patient database.

A patient entry can include various parameters. The parameters can be personal data of the patient, such as name, age, weight etc. for example. The parameters can also be medical information data of the patient such as prior illnesses, measurements already performed on the patient, planned measurements or therapies of the patient etc. The parameters can also include settings of the medical device specific to the patient, especially relating to the comfort of the patient. Such settings can for example be illumination scenarios or music requested by the patient, which will be played during the examination and/or treatment. Medical image data of the patient can also be assigned to the patient entry.

The code of the at least one patient entry can be an identifier of the at least one patient entry. The code of the at least one patient entry can also include an identification number and/or an identification code. The code of the at least one patient entry thus advantageously identifies the at least one patient entry in the patient database. The code of the at least one patient entry can also be an assignment of a patient to the patient entry and/or make a patient identification possible. Thus for example the code of the at least one patient entry can refer to a storage location of the at least one patient entry in the patient database. For the transmission of the code of the at least one patient entry the first computer advantageously communicates with the second computer. Therefore, especially for the transmission of the code of the at least one patient entry, the first computer and the second computer are connected to one another in respect of an exchange of data. Advantageously authentication information can be transmitted from the first computer to the second computer in addition to the transmission of the code. This enables it to be insured that the first computer is being operated by an authenticated user. The authentication can be performed by a method familiar to the person skilled in the art.

The selection of the at least one patient entry at the first computer especially comprises an activation of the at least one patient entry at the first computer. The selection of the at least one patient entry at the first computer is especially done manually.

The activation of the at least one patient entry at the second computer is especially done automatically. The activation of the at least one patient entry at the second computer is advantageously done when the second computer has received the code of the at least one patient entry from the first computer. Thus the selection of the at least one patient entry at the first computer occurs at a time before the activation of the at least one patient entry at the second computer system.

The proposed method offers the advantage that the at least one patient entry only has to be selected once at the first computer and can then be activated automatically at the second computer. Thus the manual selection and activation of the at least one patient entry at the second computer can be dispensed with. Thus a manual search which would possibly be time-consuming as a result of the complicated patient name and/or a missing registration of the patient can be dispensed with after the at least one patient entry at the second computer.

Through this procedure, an especially rapid, simple and efficient activation of at least one patient entry at the second computer is made possible by means of the proposed method. The patient data can be acquired especially easily at the second computer. The operating personnel have to spend less time on activating the patient entry at the second computer, which enables the workload of the operating personnel to be reduced. For example, the operating personnel then have more time for interaction with the patient for preparing for the examination and/or treatment of a patient by means of a medical device.

In a preferred embodiment of the method, the first computer is a mobile computer.

A mobile computer is especially characterized by its capability for wireless communication. A mobile computer also typically has an integrated energy source, such as a rechargeable battery for example. The mobile computer can be a Tablet PC, for example. In particular the at least one patient entry is then selected from the patient database at the mobile computer. For this purpose the mobile computer is advantageously connected wirelessly for exchange of data, for example by a WLAN, to the patient database. Naturally further mobile computers appearing sensible to the person skilled in the art are also conceivable.

The at least one patient entry can be selected at the mobile computer, so that changes of parameters of the at least one patient entry are made at the mobile computer or parameters of the at least one patient entry will be set up. It is conceivable for example that the patient enters their personal data directly at a Tablet PC as parameters of the patient entry. It is also conceivable for operating personnel to set up or change the parameters in a personal conversation with the patient, for example in a waiting room. Thus parameters of the patient entry can be changed by means of the mobile computer independently of location.

The parameters of the at least one patient entry changed or set up by means of the mobile computer can then be synchronized with the patient database. The parameter entry selected at the mobile computer can then also be activated especially simply at the second computer by means of the proposed method.

In a further preferred embodiment of the method, the second computer is a control console of a medical device.

Especially advantageously the first computer is a mobile computer and the second computer is a control console of a medical device. Then the patient entry selected at the mobile computer can be activated especially simply at the control console of the medical device. Thus the examination and/or treatment of the patient by means of the medical device can be started earlier for example, since manual activation of the patient entry at the control console is dispensed with.

In another embodiment, after the selection of the at least one patient entry from the patient database at the first computer, changes of parameters of the at least one patient entry are made by the first computer.

In particular, the first computer is then embodied as a mobile computer. This offers an especially convenient and flexible option for making changes to the at least one patient entry. Possible parameters have already been given in the previous section.

In another embodiment, the first computer, after the activation or during the activation of the at least one patient entry at the second computer, transfers the changes made to the parameters to the second computer.

The activation of the at least one patient entry at the second computer can initiate the, especially direct, transmission of the changes made to the parameters. It can thus be insured that the parameters of the at least one patient entry activated at the second computer are up-to-date. In particular no access to the patient database is necessary for the direct transmission of the parameters from the first to the second computer. Thus the parameters can be updated even if access to the patient database is not possible or is disrupted.

In another embodiment, the second computer, after the activation or during the activation of the at least one patient entry at the second computer, the changes made to the parameters from the patient database are synchronized.

This is an alternate or additional option to that described in the previous section for updating the parameters of the at least one patient entry activated at the second computer. The activation of the at least one patient entry at the second computer can initiate a synchronization of the parameters of the at least one patient entry. In particular the changes of parameters of the at least one patient entry changed by means of the first computer can be synchronized. For this the changes made to the parameters of the at least one patient entry are advantageously initially transmitted by the first computer to the database and are stored in the database.

In another embodiment, the code is transmitted by Near Field Communication and/or Bluetooth.

Transmission by Near Field Communication (NFC) is especially advantageous over short distances, for example of up to 1 meter. In particular transmission by means of Near Field Communication can require a specific spatial localization of the first computer and/or the second computer. If for example the first computer is embodied as a mobile computer, a localization of the mobile computer to a specific location can be necessary for the transmission of the at least one code. It can thus advantageously be insured that the code of the at least one patient entry is not accidentally transmitted and the at least one patient entry is not accidentally activated at the second computer. Near Field Communication also makes an especially simple network setup possible.

Transmission by Bluetooth requires that the first computer and the second computer be located in one room, for example in a control room of a medical device. Thus the code of the at least one patient entry can be transmitted and the at least one patient entry can be activated at the second computer as soon as the first computer is located in the room of the second computer.

In another embodiment, the activation of the at least one patient entry at the second computer includes taking into account the signal strength of the transmission by Near Field Communication and/or Bluetooth.

This is especially advantageous if there are a number of second computers located in the vicinity of the first computer. Then the transmission of the code of the at least one patient entry from the first computer can take place to that second computer of the number of second computers at which a higher signal strength is present. Thus the at least one patient entry is advantageously activated at that second computer of the number of second computers which is located nearer to the first computer.

The activation of the at least one patient entry at the second computer can advantageously include taking account of a change of signal strength of the transmission by means of Near Field Communication and/or Bluetooth. It can thus be established for example that the position of the first computer is getting further away from the second computer. Based on this information, the at least one patient entry can then be activated at a further second computer for example.

In another embodiment, the transmission of the code of the at least one selected patient entry and/or the activation of the at least one patient entry at the second computer is done automatically if the first computer is located within a pre-specified distance from the second computer.

In particular the first computer is embodied as a mobile computer for this purpose. Thus the at least one patient entry can be activated at the second computer especially easily. Especially advantageously the pre-specified distance is a signal range of transmission by means of Near Field Communication and/or Bluetooth.

The code of the at least one selected patient entry can be transmitted and/or the at least one patient entry can be activated at the second computer on the basis of an entry into an input unit of the first computer and/or the second computer. In particular this enables the activation of the at least one patient entry to be manually confirmed.

Naturally the code can also be transmitted by wire. Other transmission paths, for example WLAN or RFID can also be used to transmit the code.

The invention also encompasses a computer that has a patient database, a first computer and a second computer, wherein the patient database, the first computer and the second computer are configured to perform the inventive method. Thus the computer system is configured to perform a method for activating the at least one patient entry stored in the patient database.

The first computer and the patient database are configured to select the at least one patient entry from the patient database at the first computer. The first computer and the second computer are embodied to transmit a code of the at least one selected patient entry from the first computer to the second computer. The second computer is embodied to activate the at least one patient entry at the second computer on the basis of the received code of the at least one selected patient entry.

The computer system can have further control components which are needed and/or advantageous for performing an inventive method. Computer programs and further software can be stored on a memory unit of the computer system, especially of the first and/or second computer, by which a processor of the computer system automatically controls and/or executes the sequence of an inventive method.

The invention further encompasses a medical apparatus having a medical device and an inventive computer system. The computer system can be configured for transmitting the control signals to the medical device and/or receiving control signals and/or processing these signals in order to perform an inventive method. The computer system can be integrated into the medical device. The computer system can also be installed separately from the medical device. The computer system can be connected to the medical device.

The advantages of the inventive computer system and of the inventive medical device essentially correspond to the advantages of the inventive method, which have been described in detail above. Features and advantages or alternate forms of embodiment mentioned here are likewise also applicable to the other aspects of the invention, and vice versa. The functional features of the method are embodied by corresponding physical modules, especially hardware modules.

### BRIEF DESCRIPTION OF THE DRAWINGS

FIG. 1 schematically illustrates an inventive medical device with an inventive computer system.

FIG. 2 is a flow chart of a first embodiment of an inventive method.

FIG. 3 is a flow diagram of a second embodiment of an inventive method.

### DESCRIPTION OF THE PREFERRED EMBODIMENTS

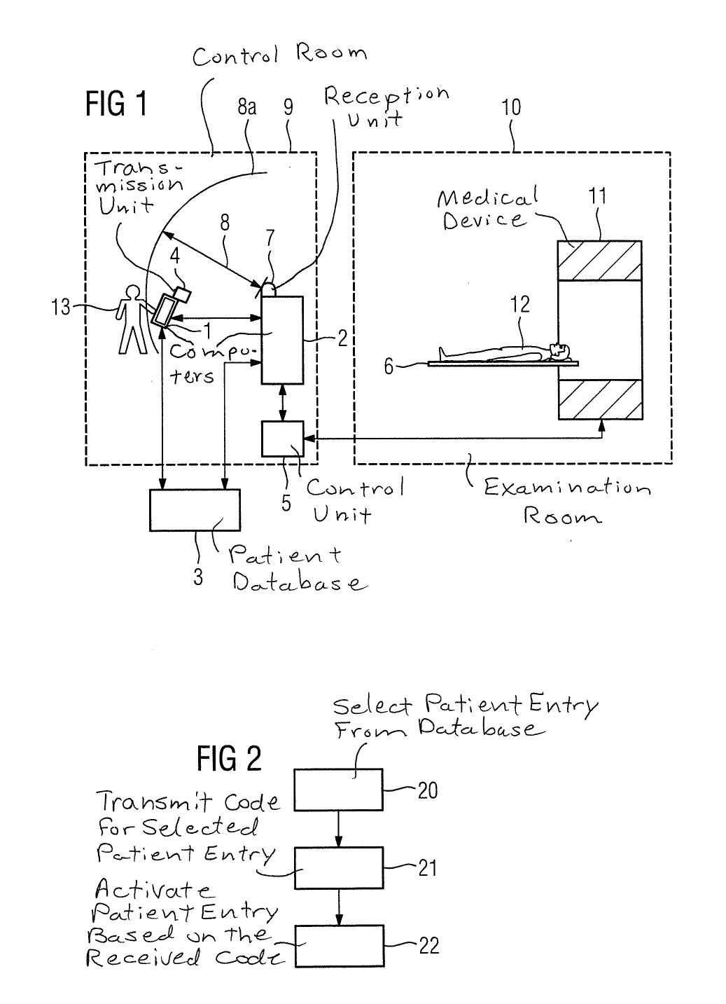

FIG. 1 shows an inventive medical device 11 with an inventive computer system in a schematic diagram. The medical device 11 is, as an example, a medical imaging device 11. The medical imaging device 11 can be a magnetic resonance device, a Single Proton Emission Tomography device (SPECT device), a Positron Emission Tomography device (PET device), a computed tomography apparatus, an ultrasound device, an x-ray device or a C-arm device etc. Combined medical imaging devices 11 are also possible here, which include any given combination of a number of the said imaging modalities. The medical device can as an alternative also be an interventional examination facility and/or a therapy facility, for example an angiographic, cardiological, nephrological or urological examination facility and/or therapy facility.

The medical imaging device 11 has, for example, a patient support unit 6 on which a patient 12 who is to be examined by means of the medical imaging device is positioned. The medical imaging device 11 is disposed in an examination room 10. The medical imaging device 11 is controlled by a control unit (computer) 5. For this purpose the medical imaging device 11 is connected to the control unit 5 in respect of an exchange of data. The control unit, in the case shown, is located in a control room 9.

The inventive computer system includes a first computer 1, a second computer 2 and a patient database 3.

In the case shown the first computer 1 is embodied as a mobile computer 1. The mobile computer 1, as is shown in FIG. 1, is a tablet computer which is operated by operating personnel 13. Naturally the first computer 1 can also be embodied differently than as shown, as appears sensible to those skilled in the art.

The second computer 2 is embodied in the case shown as a control console 2 of the medical imaging device 11. The control console 2 is likewise disposed in the control room 9. The control console 2 is connected to the control unit 5 in respect of an exchange of data. Thus for example the information as to which patient 12 is currently to be examined by means of the medical imaging device 11 is transmitted from the control console 2 to the control unit 5. Depending on this information, specific parameters can then be set for example by the control unit 5 during the examination.

Naturally the second computer 2 can also be embodied differently than as shown, as appears sensible to those skilled in the art. For example an alternate form of embodiment is conceivable in accordance with which the first computer 1 is a stationary computer and the second computer 2 is a mobile computer.

A patient entry can be activated at the mobile computer 1 and/or the control console 2. The patient entry is stored in a patient database 3. In particular the patient entry has a code, which for example specifies the storage location of the patient entry in the patient database 3. In the case shown the patient database 3 is held on a central computer which especially is located outside the control room 9 and the examination room 10. The central computer and thus the patient database 3 are connected to the mobile computer 1 in respect of an exchange of data, especially wirelessly. The central computer and thus the patient database 3 are connected to the control console 2 in respect of an exchange of data.

In the case shown a patient entry selected by the operating personnel 13 at the mobile computer 1 is to be activated at the control console 2. For this purpose a code of the selected patient entry is to be transferred from the mobile computer 1 to the control console.

To transmit the code the mobile computer 1 has a transmission unit 4. The transmission unit can be a Bluetooth transmitter or a transmitter for Near Field Communication for example. Accordingly the control console 2 has a reception unit 7 for receiving the code. The reception unit 7 can be a Bluetooth receiver or a receiver for Near Field Communication for example. Naturally other options for transmitting the code from the mobile computer 1 to the control console 2 appearing sensible to the person skilled in the art are conceivable.

The reception unit 7 has a pre-specified distance 8 around the reception unit 7. The radius 8a belonging to the pre-specified distance is shown in FIG. 1 by a dashed line. The pre-specified distance 8 is for example a signal range of a transmission by Bluetooth and/or Near Field Communication. The patient entry can then be activated at the control console 2 when the mobile computer 1 is located within the pre-specified distance 8 around the reception unit 7.

FIG. 2 shows a flow chart of a first embodiment of the inventive method for activating at least one patient entry stored in a patient database 3. The method shown in FIG. 2 can be executed by the computer system shown in FIG. 1.

In a first method step 20 the at least one patient entry is selected from the patient database 3 at a first computer 1. It is conceivable in this case for operating personnel 13 to select the patient entry at a mobile computer system 1.

In a further method step 21 a code of the at least one selected patient entry is transmitted from the first computer 1 to a second computer 2. The code can be transmitted for example by means of the transmit unit 4 of the first computer 1 and a receive unit 7 of the second computer 2.

In a further method step 22 the at least one patient entry is activated at the second computer 2 on the basis of the received code of the at least one selected patient entry. Thus the at least one patient entry can be activated particularly easily for example at a second computer 2 embodied as a control console 2 of a medical device 11. A renewed search of the second computer 2 in the patient database 3 for the at least one patient entry is not necessary.

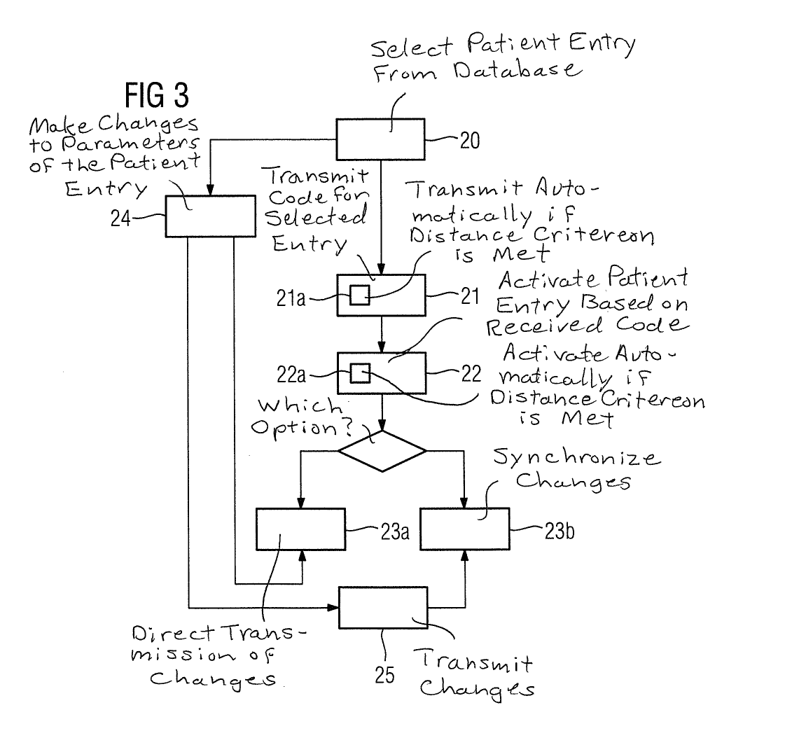

FIG. 3 shows a flow diagram of a second embodiment of the inventive method for activating at least one patient entry stored in a patient database 3. The description given below is restricted essentially to the differences from the exemplary embodiment in FIG. 2, wherein the user is referred, in respect of method steps which remain the same, to the description of the exemplary embodiment in FIG. 2. Method steps which essentially remain the same are basically labeled with the same reference numbers.

The second exemplary embodiment of the inventive method shown in FIG. 3 includes the method steps 20, 21, 22 of the first embodiment of the inventive method in accordance with FIG. 2. The second embodiment of the inventive method shown in FIG. 3 includes additional method steps and substeps. An alternate method sequence to that shown in FIG. 3 is also conceivable, which only has a part of the additional method steps and/or substeps shown in FIG. 2. Naturally an alternate method sequence to that shown in FIG. 3 can also have additional method steps and/or substeps.

After the selection of the at least one patient entry at the first computer 1 from the patient database 3 in first method step 20, changes to parameters of the at least one patient entry are made by means of the first computer 1. In particular the operating personnel 13 can make the changes at the first computer 1. For example parameters relating to the already selected patient 12, such as the age of the patient 12, can be set.

The code of the at least one selected patient entry is transmitted from the first computer 1 to the second computer 2 in further method step 21, for example by means of Near Field Communication and/or Bluetooth. In this case the code of the at least one selected patient entry is transmitted and/or the at least one patient entry is activated at the second computer 2 automatically in a substep 21a, if the first computer 1 is within a pre-specified distance 8 (see FIG. 1), for example the signal range of transmission by means of Near Field Communication and/or Bluetooth to the second computer 2. The pre-specified distance 8 thus is a distance criterion.

The further method step 22, the activation of the at least one patient entry at the second computer 2 on the basis of the received code of the at least one selected patient entry, also comprises a substep 22a. During this substep 22a, for the activation of the at least one patient entry at the second computer, a signal strength of the transmission by means of Near Field Communication and/all Bluetooth is taken into account.

After the activation or during the activation of the at least one patient entry at the second computer 2 the changes made to the parameters in the further method step 24 are updated at the second computer 2. The execution sequence can proceed in two different ways for this: In a first option, in accordance with a further method step 23a, the first computer 1 transmits the changes made to the parameters to the second computer 2 after the activation or during the activation of the at least one patient entry at the second computer 2. This direct transmission of the parameters is especially sensible if access to the patient database 3 is currently disrupted. In a second option, in accordance with a further method step 23b, the second computer 2 synchronizes the changes made to the parameters from the patient database 3 after the activation or during the activation of the at least one patient entry at the second computer 2. Before this the first computer 1 transmits the changes made to the patient database 3 in a further method step 25.

The method steps of the inventive method shown in FIG. 2 and FIG. 3 are executed by the computing unit. For this purpose the computing unit includes required software and/or computer programs which are stored in a memory unit of the computing unit, especially of the first computer 1 and/or of the second computer 2. The software and/or computer programs include program code designed to execute the inventive method when the computer program and/or the software is executed in the computing unit, especially in the first computer 1 and/or in the second computer 2, by a processor unit of the computing unit, especially of the first computer 1 and/or of the second computer 2.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for activating at least one patient entry into a medical system, comprising:
from a patient database in which a plurality of patient entries are stored, selecting, via a first computer, at least one of said patient entries from said patient database;
transmitting a code representing said at least one selected patient entry from said first computer to a second computer; and
at said second computer, activating said at least one patient entry in said medical system from said code of said at least one selected patient entry received at said second computer.

2. A method as claimed in claim 1 wherein said first computer is a mobile computer.

3. A method as claimed in claim 2 wherein said second computer is a control console of a medical device of said medical system.

4. A method as claimed in claim 1 comprising, after selecting said at least one patient entry from said patient database, making changes, via said first computer, to parameters of said at least one patient entry.

5. A method as claimed in claim 4 comprising, after or during activation of said at least one patient entry at said second computer, transmitting said changes made to said parameters from said first computer to said second computer.

6. A method as claimed in claim 5 comprising, via said second computer, after or during said activation of said at least one patient entry, synchronizing said changes made to said parameters.

7. A method as claimed in claim 1 comprising transmitting said code via a transmission mode selected from the group consisting of Near Field Communication and Bluetooth.

8. A method as claimed in claim 7 comprising activating said at least one patient entry via said second computer by evaluating a signal strength of transmission of said code via said transmission mode.

9. A method as claimed in claim 7 comprising, when said first computer is situated within a predetermined distance with respect to said second computer, transmitting said code automatically.

10. A method as claimed in claim 7 comprising, when said first computer is situated within a predetermined distance with respect to said second computer, activating said at least one patient entry.

11. A medical system comprising:
a medical device;
a patient database in which a plurality of patient entries are stored;
a first computer configured to allow selection of at least one of said patient entries from said patient database;
a second computer;
said first computer being configured to transmit a code representing said at least one selected patient entry from said first computer to said second computer; and
said second computer being configured to activate said at least one patient entry in said medical system from said code of said at least one selected patient entry received at said second computer.
